(19) United States
(12) Patent Application Publication
(10) Pub. No.: US 2011/0270541 A1
(43) Pub. Date: Nov. 3, 2011

(54) AIR FLOW RATE SENSOR

(76) Inventors: Eun Jong Cha, Cheongju-City (KR); Kyung Ah Kim, Cheongju-City (KR); In Kwang Lee, Goesan-Gun (KR); Chan Gi Kim, Cheongju-City (KR)

(21) Appl. No.: 13/091,391

(22) Filed: Apr. 21, 2011

(30) Foreign Application Priority Data
Apr. 29, 2010 (KR) 10-2010-0039828

(51) Int. Cl. G01F 1/34; G06F 19/00

(52) U.S. Cl. 702/47; 73/861.42

(57) ABSTRACT

Disclosed is an air flow rate sensor capable of sensing an air flow rate and respirator air flow rate. The air flow rate sensor includes a chamber having left and right portions having same internal diameters and a central portion having an internal diameter greater than the internal diameters of the left and right portions, first and second pressure taps provided at the left and right portions of the chamber, respectively, and a pressure sensor connected to the first and second pressure taps to measure a differential pressure between the left and right portions of the chamber. There are obstacles on the path of air flow, so that exact and uniform measurement characteristics are maintained. Since energy loss is measured by using vortex, the structure of the air flow rate sensor is simplified. The air flow rate sensor is used as a respirator air flow rate sensor.

### BACKGROUND OF THE INVENTION

1. Field of the Invention

The present invention relates to air flow measurement, and more particularly to an air flow rate sensor capable of sensing an air flow rate and respirator air flow rate.

2. Description of the Related Art

In general, an air flow rate is represented as the ratio of a volume of air flowing through a predetermined sectional area with respect to time.

The air flow rate can be measured by using measurement apparatuses such as a differential pressure flowmeter, a rotameter, a magnetic flowmeter, a thermal flowmeter, a vortex flowmeter, an ultrasonic flowmeter, and a mass flowmeter.

Hereinafter, air flow rate sensors according to the related art will be described with reference to accompanying drawings.

FIGS. 1 to 6 are schematic views showing air flow rate sensors according to the related art.

FIG. 1 shows a pneumotachometer. Regarding the structure of the pneumotachometer, a flow resistance member 11 is positioned in a chamber 10 in which air flows, and a differential pressure measurement unit 12 is provided to measure the differential pressure representing at both terminals of the flow resistance member 11 when the air flows through the flow resistance member 11.

The pneumotachometer measures the differential pressure representing at both terminals of the flow resistance member 11 by using the differential pressure member unit 12 when the air flows through the flow resistance member 11.

FIG. 2 shows a turbinometer. Regarding the structure of the turbinometer, a rotational member 21 is provided on the path of air flow in the chamber 20. In this case, the rotational member 21 may include a turbine or a propeller.

The turbinometer measures the air flow rate by measuring the number of revolution of the rotational member 21 when air rotates the rotational member 21 while flowing through the chamber 20.

FIG. 3 shows a velocity-type transducer. The velocity-type transducer includes a pitot tube 31 positioned on the path of air flow of the chamber 30 and a differential pressure measuring unit 32 extending to the outside from the pitot tube 31.

The velocity-type transducer converts kinetic energy of air flowing through the internal part of the chamber 30 into dynamic pressure to measure air flow.

FIG. 4 shows a hot-wire anemometer, and the hot-wire anemometer includes a chamber 40 and a hot wire 41 positioned on the path of air flow of the chamber 40.

The hot-wire anemometer measures thermal energy, which is dissipated when the air flows through the hot wire 41, based on temperature variation.

FIG. 5 shows a vortex shedding flowmeter including a chamber 50 and a vortex generator 51 provided perpendicularly to fluid flowing in the chamber 50.

In the vortex shedding flowmeter, vortexes rotating reversely to each other are alternately generated at both sides of the vortex generator 51 when fluid flows in the chamber 50, so that Kaarmaan vortex street may be formed at the downstream. Since the generation number of vortexes per time is proportional to the flow rate of the fluid, the flow rate can be measured by detecting the frequency of the vortexes.

FIG. 6 shows an ultrasonic flowmeter, and the ultrasonic flowmeter includes a chamber 60, a transmitter 61 and a receiver 62 to transmit and receive an ultrasonic wave, and an electronic circuit 63 interposed between the transmitter 61 and the receiver 62 to perform signal processing. At least two transmitters 61, at least two receivers 62 and at least two electronic circuits 63 may be provided.

As described above, the flow rate sensor measures the flow rate of a fluid by measuring time difference when an ultrasonic wave is propagated on two paths based on a principle that the ultrasonic wave is propagated in a flowing direction of the fluid and a direction opposite to the flowing direction during times different from each other (Doppler Effect). In other words, the ultrasonic flowmeter mainly uses the time difference.

However, the conventional air flow rate sensors have the following problems.

First, in the case of the pneumotachometer, when moisture or saliva is deposited on the flow resistance member 11, a measuring characteristic may be changed.

Second, the turbinometer cannot measure an air flow rate in bi-directions. If moisture or saliva is condensed on a rotational shaft, the rotation of the turbine is affected, so that the accuracy in the air flow measurement may be lowered.

Third, in the case of the velocity-type transducer, when air flow is continuously measured, an additional device to block or remove impurities must be provided.

Fourth, in the case of the hot-wire anemometer, since a current must be applied by an amount of the discharged thermal energy to maintain a constant temperature, the structure of the hot-wire anemometer becomes complex and the volume thereof is increased. In addition, since the hot-wire anemometer is sensitive to moisture and saliva, the hot-wire anemometer may be restrictively applied to a predetermined model of high-price air flow sensors additionally including a filter and a heater.

Fifth, the vortex shedding flowmeter can accurately measure the flow rate of air flowing through a large-size pipe. However, the structures of a sensor and an appliance become complex.

Sixth, since the ultrasonic flowmeter can measure the flow rate of air flowing outside a pipe, a vibrator does not have to directly make contact with a fluid. However, since the error may be increased as fluid distribution is scattered, the fluid must be distributed through a valve, a combined line and a branch line. In other words, a straight pipe length of the chamber 60 may be lengthened. In addition, since an extremely weak signal is transmitted through a dedicated cable between a transformer and an oscillator sensor, great measurement error or malfunction may occur due to external factors.

### SUMMARY OF THE INVENTION

Accordingly, the present invention has been made to solve the above problems occurring in the prior art, and an object of the present invention is to provide an air flow rate sensor having a simple structure in which obstacles do not exist on the path of air flow.

Another object of the present invention is to provide an air flow rate sensor which serves as a respiratory air flow rate sensor having a new structure capable of measuring the flow rate of general air and monitoring the respiratory state of a critical patient or an emergency patient and is applicable to existing equipment due to an expanded application range.

In order to accomplish the above object, the present invention provides an air flow rate sensor including a chamber having left and right portions having same internal diameters and a central portion having an internal diameter greater than the internal diameters of the left and right portions, first and second pressure taps provided at the left and right portions of the chamber, respectively, and a pressure sensor connected to the first and second pressure taps to measure a differential pressure between the left and right portions of the chamber.

The air flow rate sensor according to the present invention has the following effects.

First, since obstacles do not exist on the path of air flow, so that an exact and uniform measurement characteristic can be maintained.

Second, the chamber is configured to sufficiently generate vortex so that a general-purpose pressure sensor can easily measure energy loss. Accordingly, the structure of the air flow rate sensor including the pressure sensor can be simplified.

Third, the air flow rate sensor according to the present invention can not only measure the flow rate of general fluid, but check the lug capacity of patients for the purpose of exactly measuring air flow. In addition, since obstacles do not exist on the path of air flow, the air flow rate sensor can be used as a respiratory air flow rate sensor of critical patients or emergency patients who frequently spit out saliva, phlegm, and blood phlegm.

Fourth, since the external diameters of the left and right sides of the chamber is identical to the external diameter of a standardized tube of CPR equipments and a respirator, an additional device is not required in existing equipments.

Fifth, the chamber may include a disposable chamber including a transparent acrylic material such that the chamber can be easily replaced with new one.

### BRIEF DESCRIPTION OF THE DRAWINGS

The above and other objects, features and other advantages of the present invention will be more clearly understood from the following detailed description when taken in conjunction with the accompanying drawings, in which:

FIGS. 1 to 6 are schematic views showing flow rate sensors according to the related art;

FIG. 7 is a schematic view showing an air flow rate sensor according to the present invention;

FIG. 8 is a view showing the design of a vortex-type air flow rate sensor according to the present invention;

FIG. 9 is a view showing a principle of forming a streamline of an air flow and a principle of energy loss in the air flow rate sensor according to the present invention;

FIG. 10 is a photograph showing an air flow sensor according to the present invention;

FIG. 11 is a photograph showing that the vortex-type air flow rate sensor according to the present invention is mounted on an appliance used for cardiopulmonary resuscitation;

FIG. 12 is a graph showing a quadratic function of a pressure and an air flow; and

FIG. 13 is a graph showing the comparison of an estimated air flow value and a standardized air flow value.

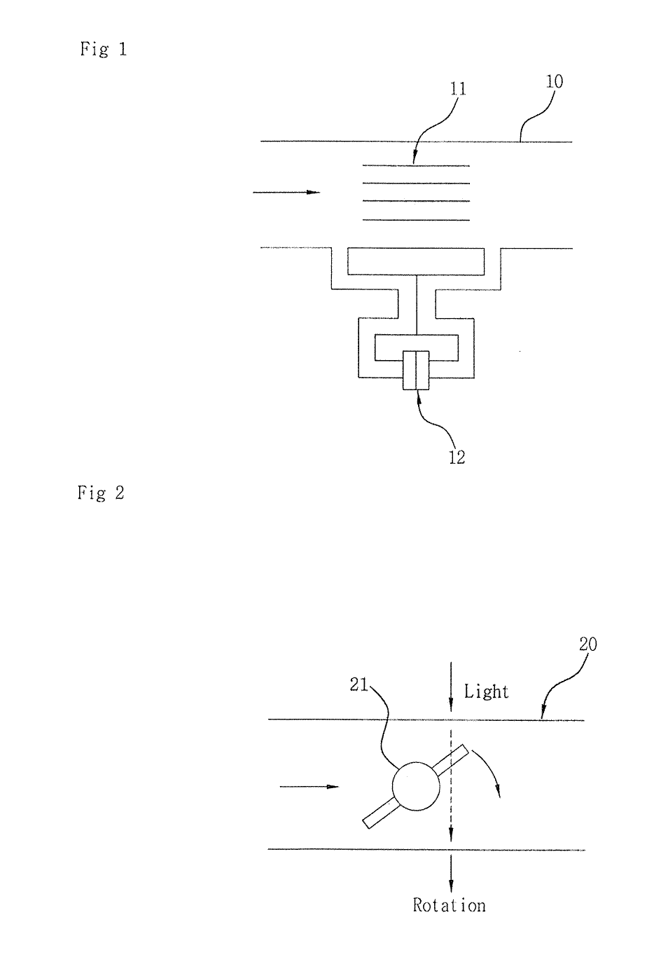

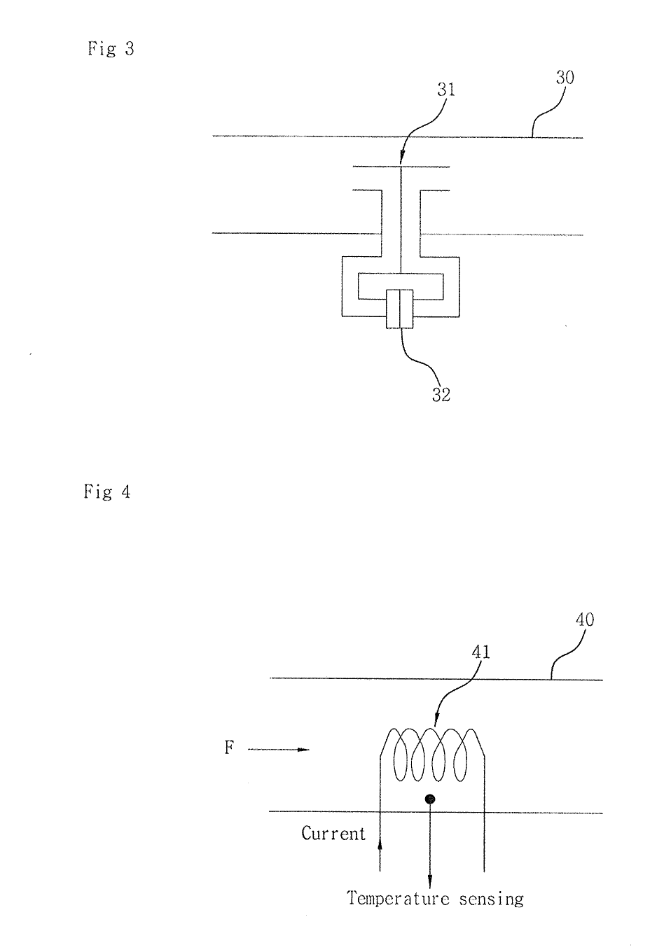

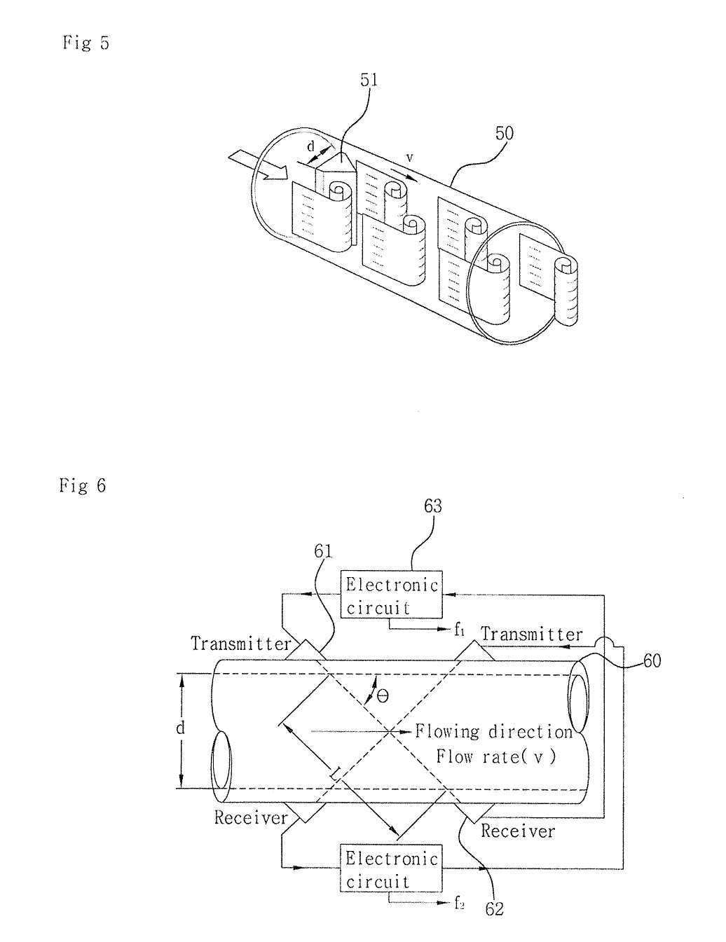

### DETAILED DESCRIPTION OF THE INVENTION

Hereinafter, exemplary embodiments of the present invention will be described in detail with reference to accompanying drawings, so that those skilled in the art can work with the embodiments.

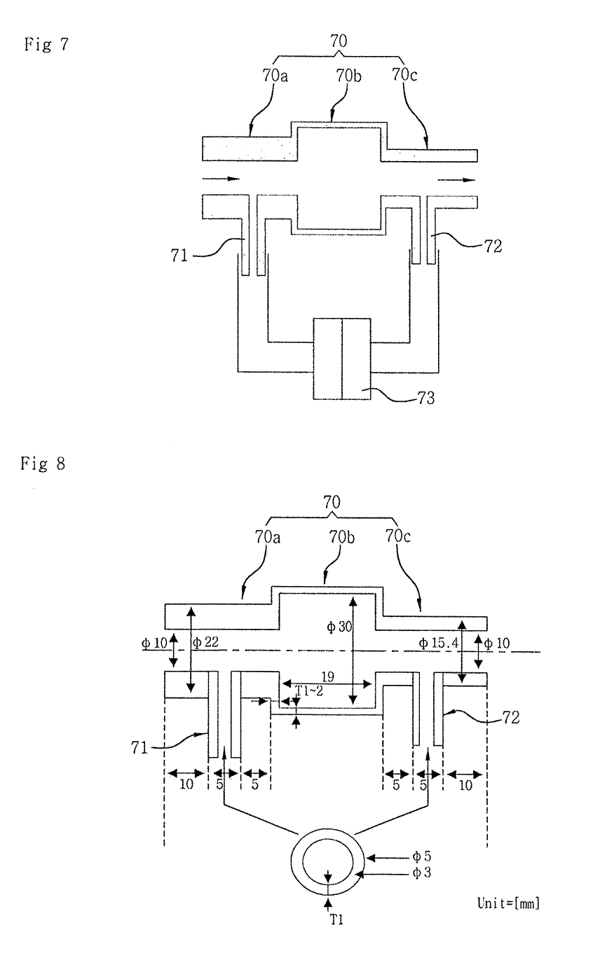

FIG. 7 is a schematic view showing an air flow rate sensor, and FIG. 8 is a view showing the design of a vortex-type air flow rate sensor according to the present invention.

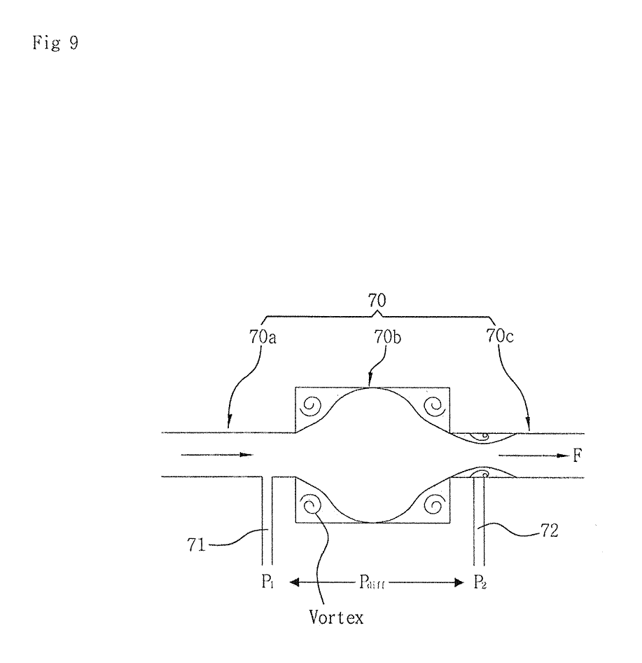

FIG. 9 is a view showing a principle of forming a streamline of an air flow and a principle of energy loss in the air flow rate sensor according to the present invention.

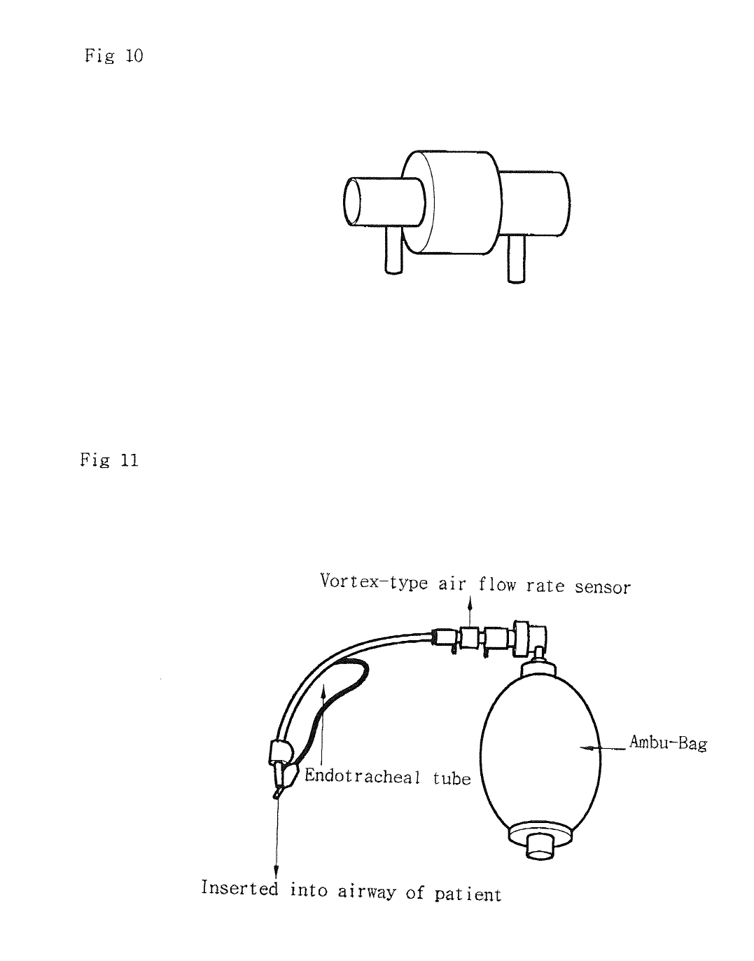

FIG. 10 is a photograph showing an air flow rate sensor according to the present invention, and FIG. 11 is a photograph showing that the vortex-type air flow rate sensor according to the present invention is mounted on an appliance used for CPR (cardiopulmonary resuscitation).

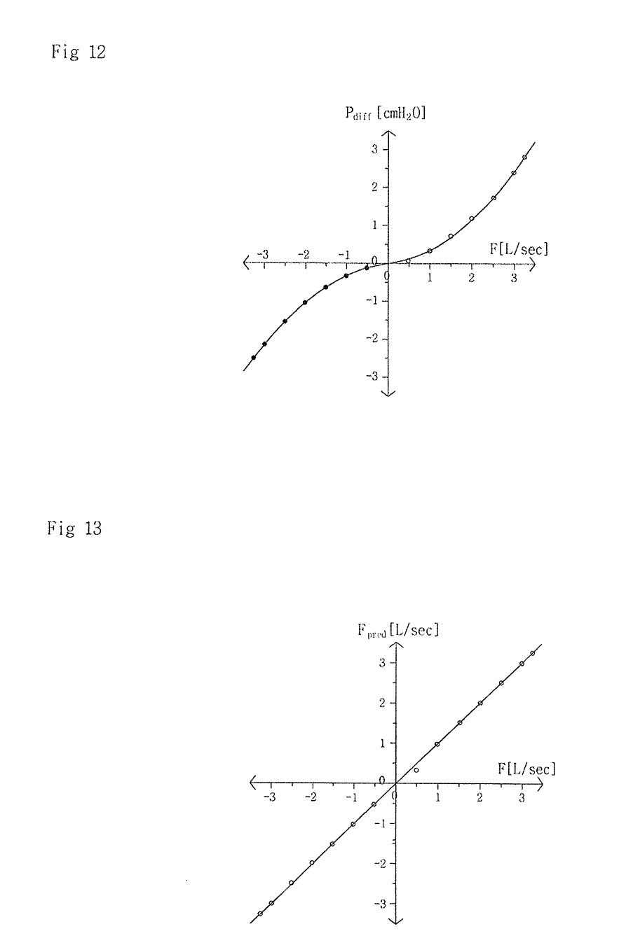

FIG. 12 is a graph showing a quadratic function of an air flow and a pressure, and FIG. 13 is a graph showing the comparison of an estimated air flow value and a standardized air flow value.

As shown in FIG. 7, the air flow rate sensor according to the present invention includes a chamber 70 having a central portion with an internal diameter greater than internal diameters of left and right portions thereof, first and second pressure taps 71 and 72 provided at the left and right sides of the chamber 70, and a pressure sensor 73 connected to the first and second pressure taps 71 and 72 to measure the pressure difference between left and right sides of the chamber 70. In this case, the pressure sensor 73 may include a general-purpose pressure sensor.

In the air flow rate sensor according to the present invention having the above structure, a vortex phenomenon is used by constructing the hollow-type chamber 70 in order to omit an additional air flow detector. The air flow rate sensor measures the air flow based on the pressure difference by using the general-purpose pressure sensor 73 connected to the first and second pressure taps 71 and 72 provided at the left and right sides of the chamber 70.

The chamber 70 may be designed to have different internal and external diameters at the left side, the central portion, and the right side thereof in order to employ the vortex phenomenon. Hereinafter, the structural characteristic of the chamber 70 will be described.

Prior to detailed description, the left side, the central portion, and the right side of the chamber 70 are defined as first, second, and third regions 70a, 70b, and 70c for the purpose of explanation about internal and external diameters.

As shown in FIGS. 7 and 8, the internal diameters of the first and third regions 70a and 70c, which are the left and right sides of the chamber 70, are identical to each other, and the internal diameter of the second region 70b which is the central portion of the chamber 70 is set to three times the internal diameters of the first and third regions 70a and 70c. For example, if the internal diameter of the first and third regions 70a and 70b is φ10, the internal diameter of the central portion of the chamber 70 may be obtained as φ30, which is three times greater than the internal diameters of the first and third regions 70a and 70c.

In this case, since internal diameters of the first and third regions 70a and 70a which are the left and right sides of the chamber 70 are identical to each other, the air flow path is maintained in a symmetric state.

In addition, if the internal diameter of the second region 70b which is the central portion of the chamber 70 is designed to three times the internal diameters of the first and third regions 70a and 70c, vortex may be sufficiently formed, so that the differential pressure Pdiff can be measured by using the general-purpose pressure sensor.

Regarding the ratio of 3:1 of internal diameters at the central portion and the left and right sides, if the second region 70b which is the central portion of the chamber 70 is designed to a smaller size, vortex is not sufficiently formed, so that an amount of lost energy is reduced. In this case, since an amount of lost energy is measured at a positive pressure in the first and third regions 70a and 70c which are the left and right sides of the chamber 70, if an amount of lost energy is reduced, a high-price pressure sensor representing superior sensitivity must be used. Accordingly, cost is increased.

In addition, if the second region 70b which is the central portion of the chamber 70 is designed to a greater size, all energy is lost due to vortex occurring even in slight air flow, and air flow does not reach the first pressure tap 71 or the second pressure tap 72 of measuring pressure. Accordingly, the accuracy of the measurement of the air flow rate may be degraded.

In addition, the external diameters of the first and third regions 70a and 70c which are the left and right sides of the chamber 70 have values different from each other, so that the air flow rate sensor is connected between an endo-tracheal tube and an ambu-bag which are standardized CPR equipments.

The first and third regions 70a and 70c, which are left and right sides of the chamber 70, are designed to have external diameters different from each other. In other words, the first and third regions 70a and 70c are designed to have external diameters identical to those of the standardized tubes of the CPR equipment and an artificial respirator, so that the air flow rate sensor can be easily connected to all equipments.

Hereinafter, examples of the external diameters of the first and third regions 70a and 70c which are the left and right sides of the chamber 70 will be described. As shown in FIG. 8, when the external diameter of the first region 70a is φ22, the external diameter of the third region 70c may be φ15.4 that is smaller than φ22.

In addition, the internal diameters of the first and second pressure taps 71 and 72 that are configured at the left and right sides of the chamber 70 may be φ5.

In addition, the thickness of the tube of the second region 70b, which is the central portion of the chamber 70, and the thickness of the tube of the first and second pressure taps 71 and 72, which are configured at the left and right sides of the chamber 70, become 1φ. In addition, the length of the second region of the chamber 70 is 19 mm, the length from the left end of the chamber 70 to the first pressure tap 71 is 10 mm, and the length from the first pressure tap 71 to the second region 70b of an adjacent chamber 70 is 5 mm. In addition, the length from the right end of the chamber 70 to the second pressure tap 72 is 10 mm, and the length from the second pressure tap 72 to the second region 70b of the adjacent chamber 70 is 50 mm.

The unit of each length shown in FIG. 8 is mm.

In addition, the central portion of the chamber 70 serves as a water trap to temporarily collecting saliva, phlegm, and blood phlegm frequently spat out from critical patients or emergency patients.

The air flow rate sensor according to the present invention having the above structure is not only used to measure the flow rate of a general fluid, but also used as a respiratory air flow rate sensor for monitoring respiratory signals of critical patients or emergency patients. In this case, the chamber includes a disposable chamber made of transparent acrylic material such that the chamber can be easily replaced with new one in order to prevent the characteristic of pressure-air flow (Pdiff-F) from being changed due to an excessive amount of impurities.

For reference, FIG. 10 is a photograph showing the air flow rate sensor, and FIG. 11 is a photograph showing that the vortex-type air flow rate sensor according to the present invention is mounted on an appliance used for CPR.

FIG. 10 shows only one example of the air flow rate sensor, but the present invention is not limited thereto.

FIG. 11 shows that the air flow rate sensor according to the present invention is connected to the endo-tracheal tube and the ambu-bag which are CPR equipments. The air flow rate sensor according to the present invention can be used as a respiratory air flow rate sensor.

Hereinafter, the operating principle of the air flow rate sensor according to the present invention will be described.

As shown in FIG. 9, air may flow from the first region 70a positioned at the left side of the chamber 70 to the third region 70c positioned at the right side of the chamber 70. The details thereof will be described below.

As shown in FIG. 9, when air flows from the first region 70a of the chamber 70 to the second region 70b, the sectional area on the path of air flow in the chamber 70 is suddenly increased. In this case, the velocity of the air flow is rapidly reduced and the streamline of the air is changed, so that the vortex is generated, thereby causing energy loss. In other words, when the sectional area is suddenly increased, the main stream of the air flows separately from the boundary wall surface where the sectional area starts to increase and then makes contact with the wall surface of a tube. In this manner, since the branch stream disturbs the peripheral air flow at the front of an enlarged tube having an enlarged sectional area, so that the vortex is generated, thereby causing energy loss.

When air flows from the second region 70h of the chamber 70 to the third region 70c, the sectional area of the chamber through which air flows is suddenly reduced. When the sectional area is reduced as described above, flow separation occurs from a narrowed position so that a concave streamline (i.e., vena contracta) is made. Therefore, the velocity of the air flow at this position is increased more than the velocity of the air flow at the upstream. In this case, the secondary loss is caused by swirling flows occurring when air flow is spread.

Energy loss caused by the generation of the vortex results in lateral pressure difference between positions before and after the sectional area is changed.

In addition, an amount of generated vortex varies according to the intensities of air flow, and the lateral pressure difference between the positions (the first and third regions 70a and 70c positioned at the left and right sides of the chamber 70) before and after the sectional area is changed may be expressed in a polynomial function of air flow as shown in Equation 1, and the polynomial function may be approximately expressed as a quadratic function. In this case, in order to more accurately measure the lateral pressure difference, a higher order polynomial function can be used.

P_{diff}=P₁−P₂=f(F)=a₁F+a₂F²+a₃F³+ . . . =a₁F+a₂F² Equation 1

In Equation 1, P₁,P₂ represent pressures at the first and third regions 70a and 70c positioned at the left and right sides of the chamber 70, P_{diff} represents the pressure difference between the first and third regions 70a and 70c positioned at the left and right sides of the chamber 70, which is measured through the first and second pressure taps 71 and 72, F is an air flow rate, and a₁,a₂,a₃, . . . are constants.

According to Equation 1, energy loss resulting from vortex phenomenon between two points is caused only by changing the sectional areas of a tube without an obstacle on the path of air flow. In this case, the differential pressure can be calculated by using the pressure sensor 73, so that the air flow rate can be calculated.

In order to ensure the measuring characteristic of an air flow rate sensor according to the present invention, an experiment for calculating the function of pressure-air flow (Pdiff-F) is performed.

When the experiment is performed, the volume signal V and the differential pressure signal Pdiff are simultaneously measured during which standardized air flow F passes.

As shown in FIG. 12, the function of the pressure-air flow (Pdiff-F) is expressed as a quadratic function having a correlation coefficient of about 0.999. Accordingly, fitting is accurately achieved.

The measured pressure value is substituted into the characteristic equation of the pressure-air flow (Pdiff-F) shown in FIG. 12 to find an estimated air flow value Fpred. The comparison of the estimated air flow value Fpred with the standardized air flow value F is represented in FIG. 13. The average relative error for the standardized air flow value F is represented as about 0.4%, so that the air flow can be accurately estimated.

When the pressure-air flow measuring characteristic experiment is performed by using the air flow rate sensor suggested in the present invention, a high correlative coefficient can be obtained.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. An air flow rate sensor comprising:
a chamber having left and right portions having same internal diameters and a central portion having an internal diameter greater than the internal diameters of the left and right portions;
first and second pressure taps provided at the left and right portions of the chamber, respectively; and
a pressure sensor connected to the first and second pressure taps to measure a differential pressure between the left and right portions of the chamber.

2. The air flow rate sensor of claim 1, wherein the chamber has a hollow form.

3. The air flow rate sensor of claim 1, wherein the central portion of the chamber has the internal diameter three times greater than the internal diameters of the left and right portions.

4. The air flow rate sensor of claim 1, wherein the left and right portions of the chamber have external diameters different from each other.

5. The air flow rate sensor of claim 4, wherein the external diameters of the left and right portions of the chamber have a size sufficient to connect the chamber between an endo-tracheal tube and an ambu-bag which are standardized CPR equipments.

6. The air flow rate sensor of claim 1, wherein the pressure sensor calculates the differential pressure between the left and right portions of the chamber by a polynomial function of air flow, in which the polynomial function is expressed as P_{diff}=P₁−P₂=f(F)=a₁F+a₂F²+a₃F³+ . . . =a₁F+a₂F².

7. The air flow rate sensor of claim 6, wherein P₁,P₂ represent pressures at the left and right portions of the chamber, P_{diff} represents a differential pressure between the left and second portions of the chamber measured by the pressure sensor through the first and second pressure taps, and the F represents an air flow rate, and a₁,a₂,a₃, . . . represent constants.

8. The air flow rate sensor of claim 1, wherein the chamber includes a disposable chamber including transparent acrylic material such that the chamber is easily replaced with a new chamber.
